(19) United States
(12) Patent Application Publication
(10) Pub. No.: US 2006/0076198 A1
(43) Pub. Date: Apr. 13, 2006

(54) Floating-caliper disk brake

(76) Inventor: Rudolf Thiel, Frankfurt am Mian (DE)

Correspondence Address: RATNERPRESTIA, P O BOX 980, VALLEY FORGE, PA, 19482-0980, US

(21) Appl. No.: 10/516,564

(22) PCT Filed: May 23, 2003
(86) PCT No.: PCT/EP03/05405

§ 371 Date: Dec. 1, 2004

(30) Foreign Application Priority Data
Jun. 17, 2002 (DE) 102 27 109.7

(51) Int. Cl. F16D 65/14

(52) U.S. Cl. 188/73.43

(57) ABSTRACT

The invention relates to a floating-caliper disc brake of a motor vehicle including a brake holder firmly attached to the vehicle and a floating caliper that is mounted on the brake holder so as to be axially displaceable. In this arrangement, the floating caliper is displaceably mounted on the brake holder, preferably by means of at least one pin guide. A radial fixation of the floating caliper on the brake holder is carried out by a locking element that is detachably secured to the floating caliper and with a portion is axially displaceably arranged on the brake holder. To improve ease of displacement of the floating caliper and to prevent undesirable radial movements of the floating caliper, the locking element is secured to the floating caliper so as to be adjustable in its radial position. As a result, it is possible to adjust a defined radial clearance between the floating caliper and the brake holder.

### TECHNICAL FIELD

The present invention relates to a floating-caliper disc brake of a motor vehicle including a brake holder firmly attached to the vehicle and a floating caliper that is mounted on the brake holder such as to be axially displaceable. In this arrangement, the floating caliper is displaceably mounted on the brake holder frequently by means of at least one pin guide.

### BACKGROUND OF THE INVENTION

Thus, DE 40 24 484 C2 discloses a floating-caliper disc brake of this type including a brake holder and a floating caliper wherein the floating caliper is axially displaceably mounted on the brake holder by means of pin guides. Further, the associated brake pads are axially displaceably guided on the brake holder and supported in a circumferential direction. The displaceable floating caliper is elastically clamped in relation to the brake holder in a radial direction with respect to the brake disc axis by means of a housing holding spring. To this end, the housing holding spring is detachably attached to the floating caliper, on the one hand, while it abuts under radial preload and axially displaceably on the brake holder, on the other hand. The housing holding spring prevents radial lifting of the floating caliper and undesirable rattling noises developing during braking operations. However, this necessitates very great tension forces of the housing holding spring, above all in floating calipers with a high weight, what unfavorably causes a high amount of displacement forces of the floating caliper in relation to the brake holder. In addition, the housing holding spring is subjected to very great manufacturing tolerances because the manufacturing tolerances of several individual components of the floating-caliper disc brake must be taken into consideration when rating the spring. Thus, the manufacturing tolerances will render the exact spring rating very difficult so that great variations of the spring tension force will frequently occur in practical operations.

DE 100 33 834 A1 describes another variant of a spot-type disc brake with a brake holder fixed to the vehicle and a floating caliper that is displaceably mounted on the brake holder by means of pin guides. The associated brake pads are guided in the brake holder so as to be axially displaceable and supported in a circumferential direction. At least one brake pad with lateral projections is arranged in a form fit in the brake holder in such a way that it is fixed in a radial direction within the brake holder. The floating caliper in turn is radially connected by way of a pin to the brake pad fixed at the brake holder, with the result that also the floating caliper is locked in a radial direction at the brake holder by way of the brake pad. Thus, radial lifting of the brake pad and of the floating caliper relative to the brake holder is initially prevented. However, the manufacturing tolerances of the individual components that must be taken into consideration cause an undesirably great radial clearance between brake holder, brake pad, and floating caliper so that rattling noises can develop.

### BRIEF SUMMARY OF THE INVENTION

In view of the above, an object of the invention is to provide a floating-caliper disc brake with a brake holder firmly attached to the vehicle and a displaceable floating caliper, which ensures a functionally safe and comfortable displaceable mounting support of the floating caliper on the brake holder for different caliper designs.

This object is achieved by a floating-caliper disc brake for motor vehicles comprises a brake holder firmly attached to the vehicle, on which a floating caliper is axially displaceably mounted. In particular, one or more pin guides may be arranged in this respect between the brake holder and the floating caliper. A locking element is provided for the radial fixation of the floating caliper on the brake holder, being detachably secured to the floating caliper and being arranged with at least one portion on the brake holder in an axially displaceable manner. The locking element is secured to the floating caliper so as to be adjustable in its radial position. This allows the accurate adjustment of the radial clearance between brake holder and floating caliper in conformity with the respective case of application and irrespective of any manufacturing tolerances developing. On the one hand, this arrangement ensures ease of displacement of the floating caliper in relation to the brake holder, while undesirable rattling and radial lifting of the floating caliper or of the brake pads out of the brake holder is prevented, on the other hand. The locking element active in a radial direction is designed in particular as a generally stiff component, e.g. as a sheet-metal component, in order to reduce elastic deformations and, hence, permit only a minimum scope of radial motion for the floating caliper. As a result, the development of undesirable rattling noises in defined operating conditions of the brake is reliably prevented.

For the radially adjustable attachment of the locking element at the floating caliper, a favorable aspect of the floating-caliper disc brake provides that the locking element is attached to an associated pin at the floating caliper through a radially extending elongated hole or any other appropriately sized opening, such as a U-shaped opening, a slot, a large bore, etc. The elongated hole or the opening provides an accommodation with a play for the associated pin so that a radial setting range is achieved when attaching the locking element. This allows purposefully adjusting the radial clearance between brake holder, brake pad, and floating caliper by means of the subsequent mounting of the locking element on the floating caliper. Radial displacement of the locking element permits adjusting the desired radial clearance and subsequently securing the locking element to the floating caliper. The actual attachment of the locking element to the floating caliper is carried out by means of a pin, which may preferably be configured as a screw or any other appropriate fastening bolt and is attached in an associated bore in the floating caliper. The locking element is clamped in between the floating caliper and the pin and fixed by means of this clamping effect in its radial position at the floating caliper.

According to an alternative variant of the floating-caliper disc brake, the locking element is detachably fastened to a carrier connected firmly to the floating caliper. This reduces the machining effort at the floating caliper because a fastening bore at the floating caliper for the locking element is omitted. The carrier especially has a disc-shaped design and is firmly connected to the floating caliper inside an associated opening therein, for example, by means of a press fit. The locking element can then be fastened to the carrier in a detachable manner by way of a fastening bolt, as described hereinabove.

A favorable aspect of the floating-caliper disc brake is achieved in that the portion of the locking element that is axially displaceably arranged on the brake holder has a radially elastic design. This way, it is not only possible to purposefully adjust the radial clearance between the floating caliper and the brake holder. Rather, a defined adjustment of elastic preload in a radial direction between floating caliper and brake holder is also rendered possible.

Another suitable design of the floating-caliper disc brake is achieved in that an elastic spring arm is provided at the locking element, which bears against the brake holder with a preload in circumferential direction and in an axially displaceable manner. This arrangement will clamp the floating caliper elastically in a circumferential direction in relation to the brake holder that is fixed to the vehicle. This condition proves favorable above all in defined installation positions of the floating-caliper disc brake on the vehicle wheel in terms of preventing rattling noises. The elastic spring arm is either formed integrally with the locking element or connected thereto in an appropriate fashion. The direct coupling of the elastic spring arm to the locking element favorably reduces the expenditure in components for the floating-caliper disc brake.

### BRIEF DESCRIPTION OF THE DRAWINGS

FIG. 1 shows two views of a floating-caliper disc brake with a first variant of a locking element active between the floating caliper and the brake holder.

FIG. 2 shows two views of the locking element of FIG. 1.

FIG. 3 is a side view of a floating-caliper disc brake including a second variant of the locking element.

FIG. 4 is a side view of a floating-caliper disc brake including a third variant of the locking element

FIG. 5 is a side view of a floating-caliper disc brake including a fourth variant of the locking element.

FIG. 6 is a three-dimensional view of another floating-caliper disc brake design including a fifth variant of the locking element.

FIG. 7 is a cross-section taken through a portion of the floating-caliper disc brake according to FIG. 6.

FIG. 8 shows two views of another design of the floating-caliper disc brake including a sixth variant of the locking element.

### DETAILED DESCRIPTION OF THE PREFERRED EMBODIMENTS

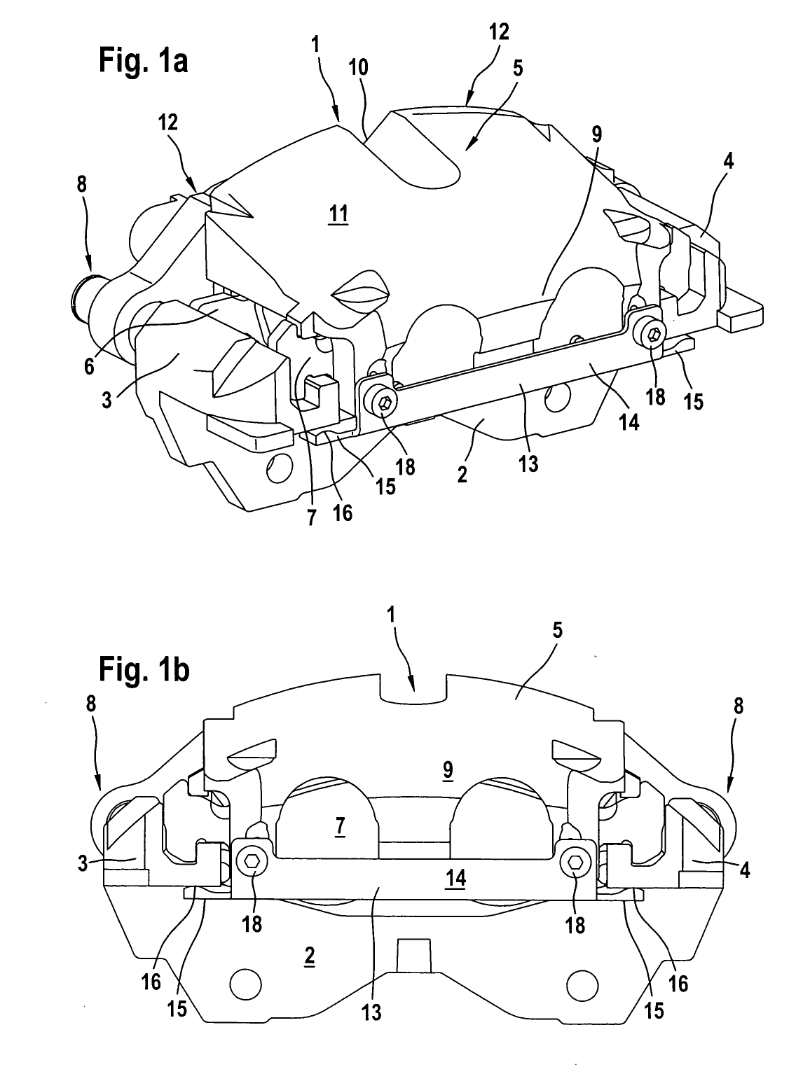

The floating-caliper disc brake 1 for a motor vehicle shown in FIGS. 1 to 5 comprises a brake holder 2 arranged firmly on the vehicle and being either integrated directly into a component on the vehicle, e.g. a steering knuckle, or mounted on a component of this type. Only those structural shapes of the brake holder 2 can be taken from the Figures, which can be mounted on the vehicle. With two axially extending holder arms 3, 4 the brake holder 2 straddles the edge of an associated brake disc, which is not shown for the sake of clarity in all the Figures. In the holder arms 3, 4, brake pads 6, 7 arranged on either side of the brake disc with respect to the brake disc axis are axially displaceably guided and supported in a circumferential direction, with said brake pads 6, 7 respectively abutting radially in the holder arms 3, 4. A brake caliper 5 that is axially displaceably mounted on the brake holder 2 straddles the brake pads 6, 7 along with the brake disc. To this end, preferably two pin guides 8 are provided which act between the floating caliper 5 and the brake holder 2 and permit the displaceable mounting support of the floating caliper 5. The floating caliper 5 comprises two caliper legs 9, 10 that extend on either side of the brake disc and are interconnected by a bridge portion 11 straddling the brake disc. Two actuating devices 12 are integrated for brake application into the caliper leg 10 that is axially inward with respect to the vehicle in order to apply a corresponding brake application force to the axially inward brake pad 6. When the brake is applied, an axial displacement of the floating caliper 5 in response to the reaction force will also cause the axially outward brake pad 7 to be pressed against the brake disc. It is, of course, also feasible to accommodate only one single actuating device or more than two actuating devices 12, respectively, in the floating caliper 5 in order to generate the brake application force.

In order to prevent undesirable rattling noises from developing between the brake holder 2, the brake pads 6, 7, and the floating caliper 5, a locking element 13 is provided that fixes the floating caliper 5 radially in position relative to the brake holder, while the axial displaceability of the floating caliper 5 remains unaffected. To this end, the locking element 13 is detachably fastened to the floating caliper 5, on the one hand, and bears axially displaceably against the brake holder 2, on the other hand. As a special aspect of the detachable attachment, the locking element 13 is arranged so as to be adjustable in its position at the floating caliper 5, which is radial with respect to the brake disc axis. This means that the radial clearance of the floating caliper 5 in relation to the brake holder 2 can be defined by way of the radial positioning of the locking element 13 at the floating caliper. The result is ease of motion of the displaceable floating caliper mounting support on the brake holder 2 irrespective of possible manufacturing tolerances.

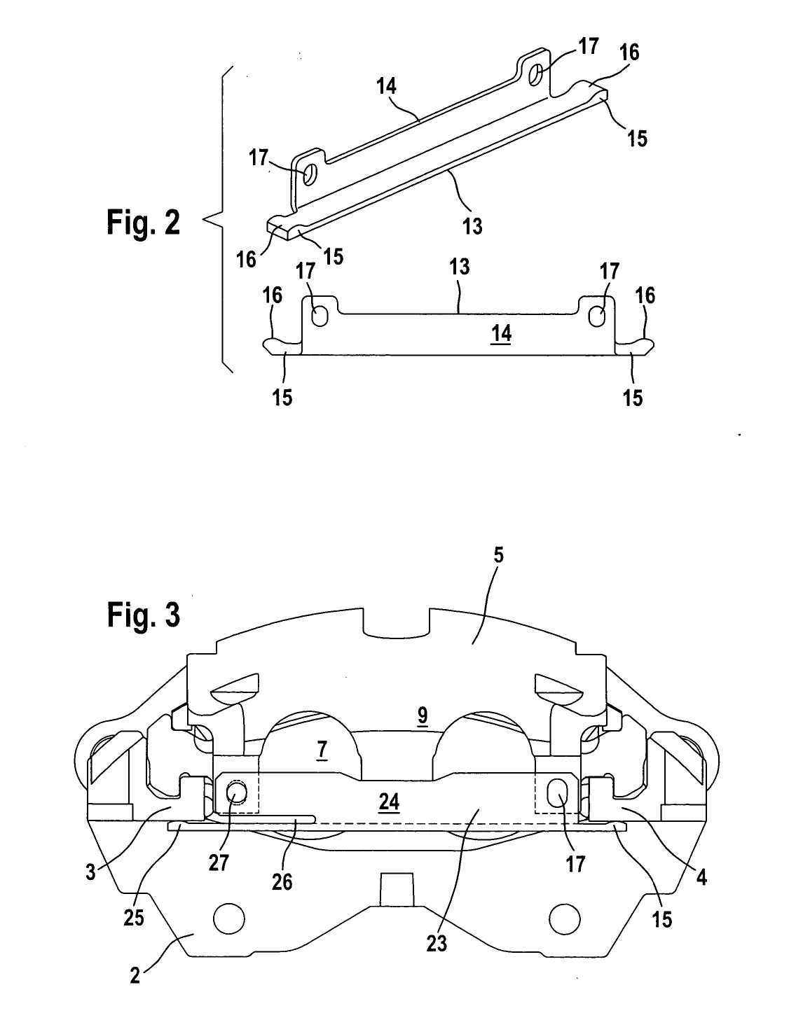

In detail, the locking element 13 is designed in particular as an L strap in a first design according to FIGS. 1 to 2, the base portion 14 of said L strap being detachably fastened at the axially outwards floating-caliper leg 9 and abutting with lateral arms 15 displaceably at the holder arms 3, 4. An L strap of this type is preferably made of a sheet-metal blank, but it can also consist of other suitable materials. Further, the locking element 13 in FIGS. 1 to 2 is configured as a one-part L strap. Of course it is similarly also possible to design a multi-part variant of the locking element 13 where e.g. the arms 15 are connected as initially separate components to the base portion 14. A variant of this type renders it possible to use different materials for the base portion 14 and the arms 15.

In the ready assembled condition, the arms 15 of the locking element 13 secured to the floating caliper 5 bear against the bottom side of the holder arms 3, 4 in an axially displaceable manner. Arms 15 have a generally rigid design and thereby prevent a radially pointing movement of the floating caliper 5 in relation to the brake holder 2. For greater ease of displacement, each arm 15 includes a radial elevation 16, whereby the contact surface between arm 15 and holder arm 3, 4 is reduced. The locking element 13 is principally adjustable in its radial position and detachably secured to the floating caliper 5. At least one radially extending elongated hole 17 is designed in the base portion 14. The locking element 13 of FIGS. 1 to 2 even includes two elongated holes 17 through which fastening screws 18 extend, which in turn are screwed into the axially outwards floating-caliper leg 9. Consequently, locking element 13 is arranged at the floating caliper 5 so as to be radially adjustable in its position within the dimensions of the elongated hole. To begin with, the floating caliper 5 is axially displaceably mounted on the brake holder 2 prior to the initiation of a floating-caliper disc brake 1 of this type. Subsequently, the locking element 13 is attached in a predefined radial position at the floating-caliper leg 9 by tightening the fastening screws 18. For detachably fastening the locking element 13 to the floating caliper 5, it is also feasible to use other fastening bolts or similarly acting fastening means in addition to the fastening screw 18 shown. Besides, the locking element can also be suspended on one side at the floating-caliper leg 9, while it is screwed to the floating caliper at the other side in a radially adjustable fashion. In such a variant, preferably one hook is designed at the locking element on one side thereof, which hook can be suspended into an associated opening in the outward floating-caliper leg. An elongated hole is designed on the opposite side of the locking element in order to make the radial positioning adjustable. The elongated holes 17 principally allow the defined adjustment of the radial clearance between floating caliper 5 and brake holder 2. If desired, this radial clearance adjustment may also relate to one or to both of the brake pads 6, 7 when the floating caliper 5 is radially supported on the brake holder 2 by means of at least one brake pad 6, 7. Thus, the radial clearance between the brake holder 2, the brake pads 6, 7, and the floating caliper 5 can be determined purposefully by means of the locking element 13. This allows compensating the manufacturing tolerances of all individual components of the floating-caliper disc brake 1 under review during the radial positioning of the locking element 13. Consequently, it is possible to arrange the floating caliper 5 either without a radial clearance or with a defined radial clearance relative to the brake holder 2 irrespective of manufacturing tolerances of the individual components. This prevents the development of undesirable rattling noises and further improves in general the displaceable mounting support of the floating caliper 5 on the brake holder 2.

FIG. 3 shows a second embodiment of the locking element 23 being fastened at the floating-caliper leg so as to be adjustable in its radial position. In contrast to the first variant, the locking element 23 of FIG. 3 includes a first, generally rigid lateral arm 15 and a second arm 25 that is elastical at least in a radial direction. The two arms 15, 25, as is known, bear axially displaceably against the bottom side of the holder arms 3, 4. The elastic second arm 25 is generally formed in that an indentation 26 is provided in the base portion 24. This will effect elastic deformability of the second arm 25 so that the locking element 23 can produce a spring bias in a radial direction by means of this arm 25. This allows clamping the floating caliper 5 and the brake pads 6, 7 radially in relation to the brake holder 2 that is fixed to the vehicle. In particular, the radially clearance-free arrangement of brake holder 2, brake pads 6, 7, and floating caliper 5 can be ensured. A first elongated hole 17 and a second through hole 27 are provided in the base portion 24 for the radially adjustable attachment of the locking element 23 at the floating-caliper leg 9. In the ready assembled condition, associated fastening screws or bolts that are detachably secured in the floating caliper 5, project through these holes 17, 27. The through hole can be designed either as a circular hole or as an elongated hole. However, the radial clearance or the freedom from clearance is adjusted on the opposite side of the locking element 23 at the first elongated hole 17 by a corresponding attachment of the associated fastening bore or screw. To this end, the locking element 23, by means of using the resilient effect of the radially elastic arm 25, is swiveled about the through hole 27 and secured to the floating caliper 5 by way of the elongated hole 17 when the desired radial clearance is reached.

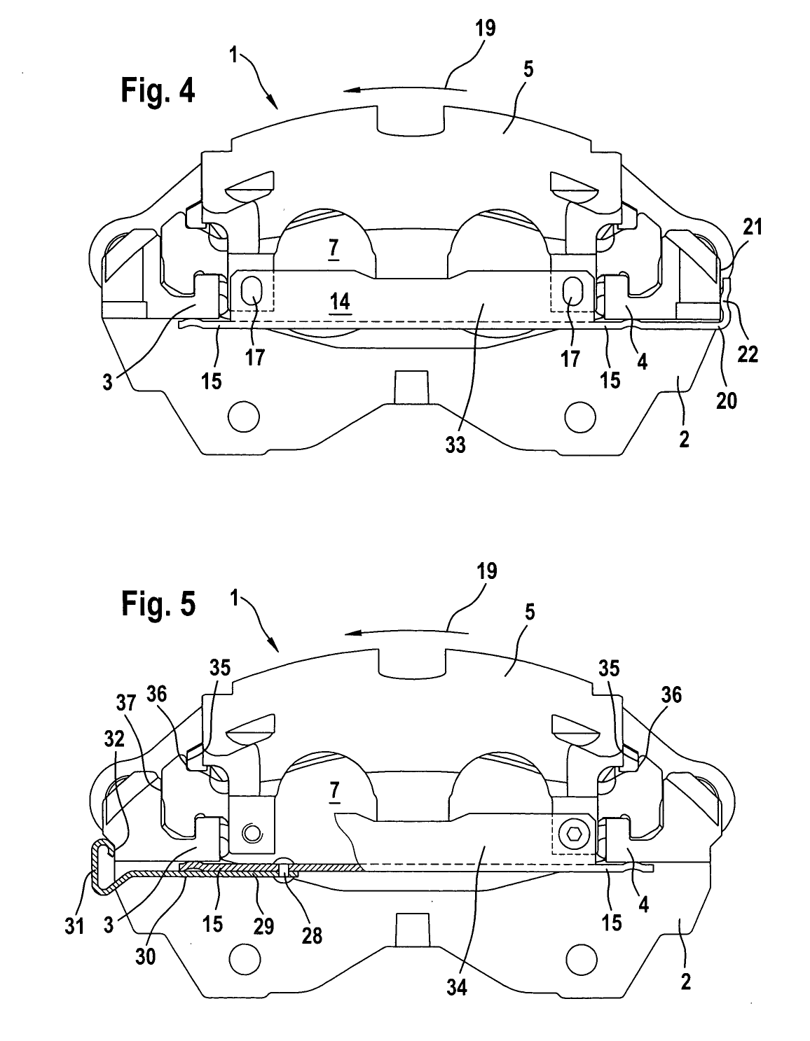

FIGS. 4 and 5 depict further developments of the locking element 33, 34. As described hereinabove, the locking element 33, 34 is preferably configured as an L strap which can be attached to the floating caliper 5 so as to be adjustable in its radial position and bears with lateral arms 15 displaceably against the holder arms 3, 4 of the brake holder 2. The above-mentioned elongated holes 17 are provided in the base portion 14 for the detachable and radially adjustable attachment of the locking element 33 at the floating caliper 5. The general function of the locking element 33, 34, in particular for the defined determination of the radial clearance between brake holder 2, the brake pads 6, 7, and the floating caliper 5 is maintained, as has already been described by way of FIGS. 1 to 3.

According to FIG. 4, the locking element 33 includes an integrally formed spring arm 20, which is configured as an extension of arm 15 in the embodiment illustrated. However, the spring arm 20 can also be connected to the locking element 33 at a different location. In detail, the spring arm 20 abuts under bias in a circumferential direction on an associated contact surface 21 at the holder arm 4 in an axially displaceable fashion. To this end an elevation 22 is shaped at spring arm 20 to reduce the friction effect in relation to the contact surface 21. The bias of the spring arm 20 is used to clamp the floating caliper 5 preferably together with the brake pads 6, 7 in a circumferential direction relative to the brake holder 2. This prevents undesirable rattling noises between the individual brake components, as they may occur especially in unfavorable installation situations of the floating-caliper disc brake 1 at the vehicle wheel. The spring arm 20 according to FIG. 4 cooperates with the holder arm 4 that is on the entry side with respect to the main direction of rotation 19 of the brake disc, that means during forward travel. This allows clamping the floating caliper 5 and the brake pads 6, 7 connected therewith in relation to the entry-side holder arm 4 in opposition to the main direction of rotation 19. Depending on the installation situation of the floating-caliper disc brake 1, however, it may also be advisable to arrange the spring arm 20 at the opposite end of the locking element 33 and make it interact with the exit-side holder arm 3.

FIG. 5 shows another embodiment of the locking element 34 with spring arm 30 modified compared to FIG. 4. The spring arm 30 is designed herein as a separate component, which is connected with its fastening portion 29 to the locking element 34 by way of an appropriate fastening means 28, for example a rivet. This allows the spring arm 30 a free and defined layout with respect to its design and the selection of its material. Further, the spring arm 30 comprises a curved spring portion 31, which abuts on a correspondingly configured contact surface 32 at the holder arm 3 under bias in a circumferential direction so as to be axially displaceable. The curved configuration of the spring arm 31 allows realizing appropriate spring characteristic curves that permit purposefully determining the desired spring biasing force. In contrast to the variant according to FIG. 4, the spring arm 30 according to FIG. 5 cooperates with the holder arm 3 that is on the exit side with respect to the main direction of rotation. The floating caliper 5 along with the brake pads 6, 7 is thereby clamped in a circumferential direction with respect to the exit-side holder arm 3 by way of the locking element 34 secured to the floating caliper 5. More specifically, the resilient preload of the spring arm 30 by means of associated abutment surfaces 35, 36 urges the floating caliper 5 through the axially outward brake pad 7 against a supporting surface 37 on the exit-side holder arm 3. This provision reliably prevents rattling of the individual brake components irrespective of the specific mounting situation or defined operating conditions.

The spring arm 20, 30 shown in FIGS. 4 to 5 and used to clamp the floating caliper 5 and the brake pads 6, 7 in relation to the brake holder 2 in a circumferential direction may principally be transferred also to other embodiments of the floating caliper 5 or the brake holder 2, respectively. It is important that the respective spring arm 20, 30 can generate a resilient preload in a circumferential direction between these two components irrespective of the specific design of the floating caliper or the brake holder, respectively.

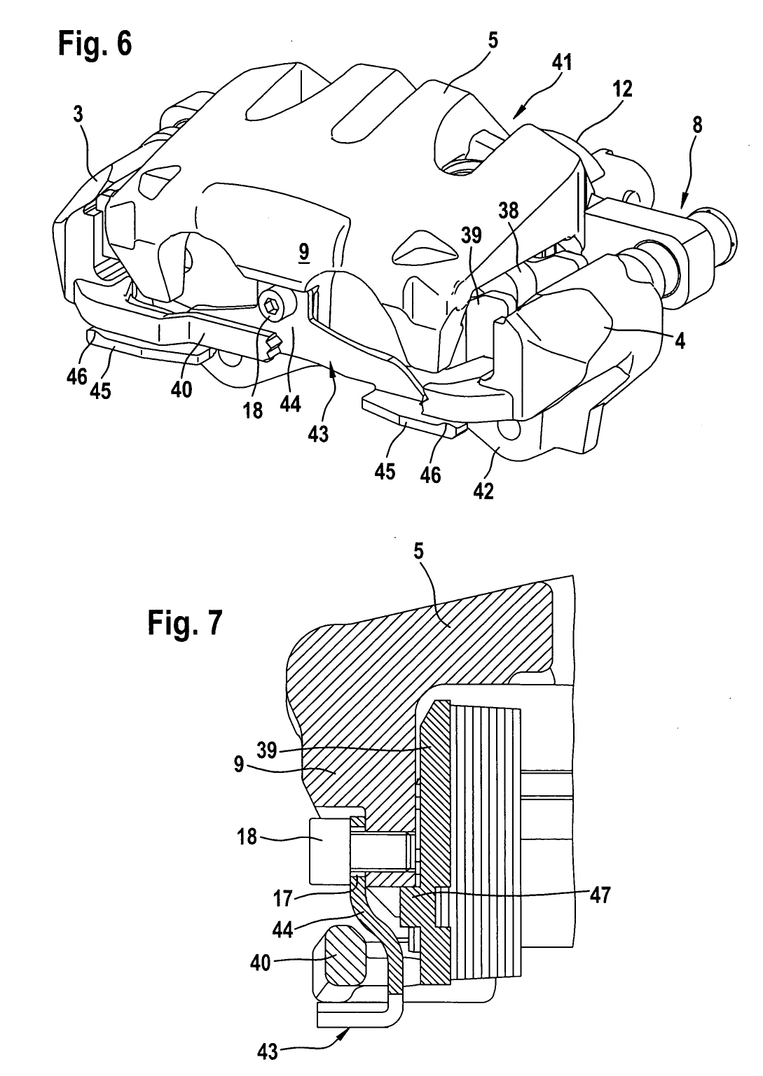

FIGS. 6 to 7 show an alternative variant of the locking element 43 for a modified construction of the floating-caliper disc brake 41. In this variant the floating caliper 5 is arranged on the brake holder 42 fixed to the vehicle in a similar way slidable by means of two pin guides 12. The floating caliper 5 straddles in a known fashion a brake disc not shown and brake pads 38, 39 arranged on either side of the brake disc and slidably guided in the holder arms 3, 4 and supported in a circumferential direction. However, the axially extending holder arms 3, 4 are interconnected by means of a web 40. This causes a considerable reinforcement of the brake holder 42, as is required especially in very efficient floating-caliper disc brakes. Web 40 is used to reduce the deformation of the brake holder 2 or the holder arms 3, 4, respectively, due to an applied brake torque. At its base portion 44, the locking element 43 that is conformed to the construction of the floating-caliper disc brake 41 is releasably secured to the axially outwards floating-caliper leg 9 by means of one single fastening screw 18 or any comparable fastening means. The radially adjustable positioning of the locking element 43 at the floating caliper 5 is effected as known by way of an elongated hole 17 in the base portion 44. For the rattle-free displaceable arrangement of the floating caliper 5 at the brake holder 42, arms 45 are designed on either side of the locking element 43 and slidably abut on the bottom side of web 40. An elevation 46 is shaped at each arm 45 in order to minimize the contact surface towards web 40 and any friction effects resulting therefrom. Thus, the arms 45 allow a radially clearance-free arrangement of the floating caliper 5 relative to the brake holder 42 according to the invention. Alternatively, it is also possible to adjust a defined radial clearance between brake holder 42 and floating caliper 5 irrespective of manufacturing tolerances of the individual components. The purposeful adjustment of the radial clearance by means of the locking element can also relate to the brake pads 38, 39 or at least one of the brake pads 39. This is illustrated in FIG. 7 wherein the floating caliper 5 due to abutment on a step 47 of the outward brake pad 39 is radially supported on said. Thus, the effect of the adjustable locking element 43 renders it possible to define the radial clearance between the brake holder 42 fixed to the vehicle, at least the outward brake pad 39, and the floating caliper 5.

Other designs of the locking element 43 active between brake holder 42 and floating caliper 5 are principally also feasible for such a construction of the brake holder 42 with web 40. It is then not absolutely necessary to equip the locking element 43 with two lateral arms 45 that bear against web 40. It is likewise possible for only one tab (not shown) to extend from the base portion 44 and embrace the web 40 similarly. This way, a purposeful adjustment of the radial clearance between floating caliper 5 and brake holder 42 is achieved just as well.

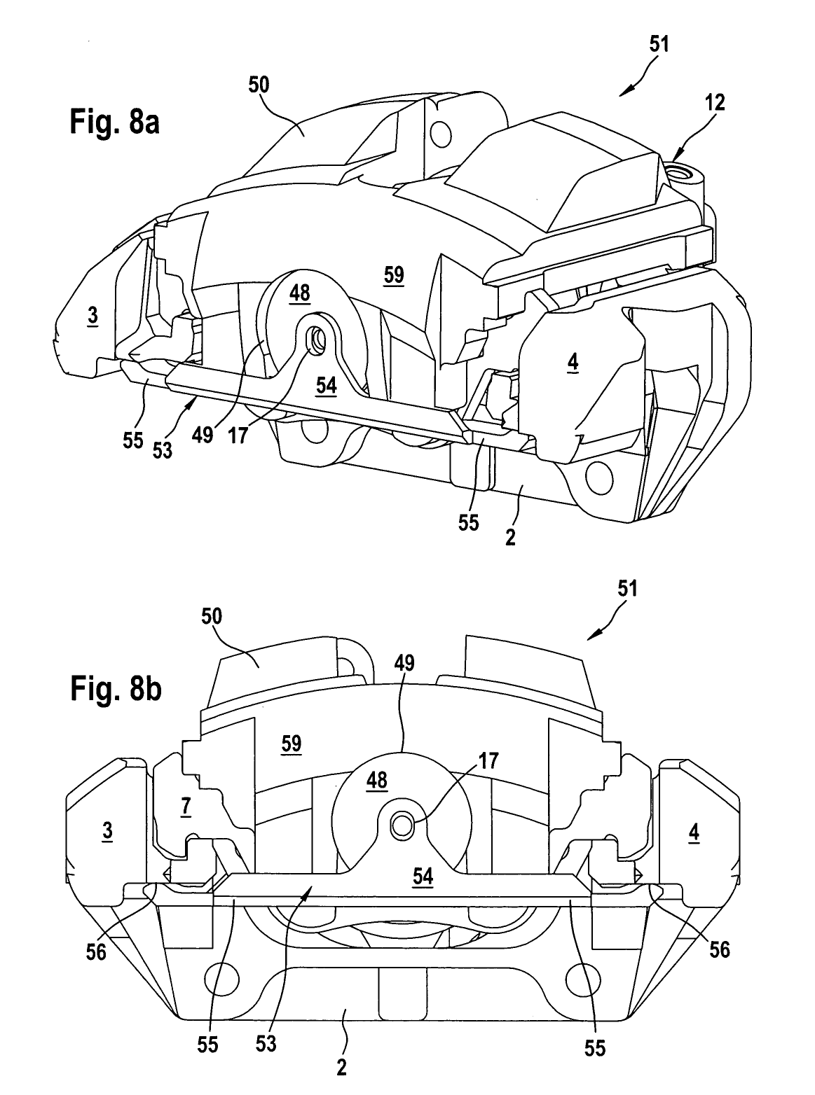

FIG. 8 displays in two views another embodiment of a locking element 53 for the adjustment of a radial clearance between floating caliper 50 and brake holder 2. The design of the floating-caliper disc brake 51 shown in FIG. 8 comprises a floating caliper 50, which is displaceably arranged on the brake holder 2 fixed to the vehicle, however, includes only one single actuating device 12 for applying a brake application force. A carrier 48 is connected to the floating caliper 5 for the radially adjustable and releasable attachment of the locking element 53 at the floating caliper 50. The carrier 48 is configured as a simple disc, for example, which is secured especially in a form fit in an associated opening 49 in the outward floating-caliper leg 59. Preferably, carrier 48 is press fitted into the concentric opening 49, said opening 49 encompassing the carrier 48 at an angle of more than 180°. The carrier 48 is this way reliably fixed in a radial direction in the floating caliper 50.

The locking element 53 can be fastened to the carrier 48 so as to be adjustable at carrier 48 by way of an elongated hole 17 in the base portion 54. It is preferred to use a fastening screw or any other fastening element (not shown) in order to releasably connect the locking element 53 to the carrier 48. Machining of the floating caliper 50 is simplified by interposing the carrier 48 in order to connect the locking element 53 releasably to the floating caliper 50.

The floating caliper 50 is locked radially with respect to the brake holder 2 by way of laterally extending arms 55 of the locking element 53 which, similar to the embodiments explained hereinabove, abut through one elevation 56 each slidably on the holder arms 3, 4. In total, the locking element 53 is thus equally active between the floating caliper 50 and the brake holder 2 fixed to the vehicle. Only the radially adjustable attachment of the locking element 53 at the floating caliper 50 takes place through an interposed carrier 48. Accordingly, any optional adjustment of the radial clearance between the brake holder 2, the brake pads 6, 7, and the floating caliper 50 is rendered possible also for this variant.

Of course, the fastening variant for the locking element 53 illustrated in FIG. 8 can also be transferred to constructions of the floating-caliper disc brake wherein several actuating devices are integrated in the floating caliper. Such floating-caliper designs with e.g. two actuating devices in each case are shown in FIGS. 1 to 7. For the radially adjustable attachment of the corresponding locking element, it is then necessary to use several, for example two, carriers in the outward floating-caliper leg. The associated locking element could then be radially adjustably and detachably secured to each carrier.

1-8. (canceled)

9. A floating-caliper disc brake of a motor vehicle including a brake holder firmly attached to the vehicle, on which a floating caliper is axially displaceably mounted, and including a locking element for the radial fixation of the floating caliper on the brake holder that is detachably secured to the floating caliper and axially displaceably arranged with a portion on the brake holder,
wherein the locking element is secured to the floating caliper so as to be adjustable in its radial position.

10. The floating-caliper disc brake as claimed in claim 9,
wherein the floating caliper is supported at least radially on an associated brake pad, which in turn is axially displaceably guided in and radially abutting on the brake holder.

11. The floating-caliper disc brake as claimed in claim 9,
wherein the locking element is attached to the floating caliper by means of at least one radially extending elongated hole or any other appropriately sized opening in which an associated pin is arranged with a clearance.

12. The floating-caliper disc brake as claimed in claim 9,
wherein the locking element is detachably fastened to a carrier connected firmly to the floating caliper.

13. The floating-caliper disc brake as claimed in claim 11,
wherein the pin is detachably secured to the floating caliper.

14. The floating-caliper disc brake as claimed in claim 11,
wherein the locking element is detachably fastened to a carrier connected firmly to the floating caliper; and
wherein the pin is detachably secured to the carrier.

15. The floating-caliper disc brake as claimed in claim 9,
wherein the portion of the locking element that is axially displaceably arranged on the brake holder has a radially elastic design.

16. The floating-caliper disc brake as claimed in claim 15,
wherein at least one elastic spring arm is provided at the locking element and bears against the brake holder with a preload in circumferential direction and in an axially displaceable manner.
